(19) United States
(12) Patent Application Publication
(10) Pub. No.: US 2023/0159109 A1
(43) Pub. Date: May 25, 2023

(54) TRACTOR

(71) Applicant: Kubota Corporation, Osaka (JP)

(72) Inventors: Satoshi Nagata, Osaka (JP); Ryuichi Inoue, Osaka (JP)

(73) Assignee: Kubota Corporation, Osaka (JP)

(21) Appl. No.: 17/975,881

(22) Filed: Oct. 28, 2022

(30) Foreign Application Priority Data
Sep. 30, 2021 (JP) 2021-162218

(51) Int. Cl. B62D 25/10; B60K 13/04

(52) U.S. Cl. CPC B62D 25/10; B60K 13/04; B60Y 2200/221

(57) ABSTRACT

A tractor includes: a vehicle body; an engine bonnet that forms an engine compartment; a first exhaust-gas cleaning device disposed above the engine in the engine compartment and purifies exhaust gas from the engine; and a second exhaust-gas cleaning device disposed behind the engine and purifies the exhaust gas from the engine, the engine compartment including: a back engine compartment portion in which the second exhaust-gas cleaning device is disposed, and a front engine compartment portion disposed further toward a vehicle-body front side than the back engine compartment portion, the engine bonnet including: a back bonnet that covers the back engine compartment portion, and a front bonnet that is configured as a separate body from the back bonnet and covers the front engine compartment portion, and the front bonnet being swingably supported to open and close.

### BACKGROUND

### Technical Field

The present invention relates to a tractor.

### Description of Related Art

Among tractors, there are those that, as illustrated in patent literature 1 for example, are provided with an engine bonnet (bonnet) forming an engine compartment; a first exhaust-gas cleaning device (first case) that, in the engine compartment, is provided above an engine (diesel engine) and subjects exhaust gas from the engine to a cleaning process; and a second exhaust-gas cleaning device (second case) that is provided behind the engine and subjects the exhaust gas from the engine to a cleaning process.

### PRIOR-ART LITERATURE

[Patent Literature 1] JP 6188219 B2

In the above tractors, the first exhaust-gas cleaning device is housed above the engine, and the second exhaust-gas cleaning device is housed behind the engine. This increases an up-down length and a front-back length of the engine compartment and increases a volume of the engine compartment such that a large engine bonnet is necessary.

### SUMMARY

One or more embodiments of the present invention provide a tractor wherein it is easy to open and close an engine compartment despite an engine bonnet being large and wherein the engine bonnet is easy to produce.

A tractor of one or more embodiments of the present invention is provided with:

a vehicle body; an engine bonnet forming an engine compartment; and a first exhaust-gas cleaning device, which is provided above an engine in the engine compartment and subjects exhaust gas from the engine to a cleaning process (purifies the exhaust gas from the engine), and second exhaust-gas cleaning device, which is provided behind the engine and subjects the exhaust gas from the engine to a cleaning process (purifies the exhaust gas from the engine); wherein the engine bonnet has a back bonnet, which covers a back engine compartment portion—wherein the second exhaust-gas cleaning device is positioned—of the engine compartment and a front bonnet, which is configured as a separate body from the back bonnet in a state of covering a front engine compartment portion—disposed further toward a vehicle-body front side than the back engine compartment portion—of the engine compartment; and the front bonnet is supported in a state wherein it can swing open and closed (swingably supported to open and close).

According to the present configuration, even if an overall size of the engine bonnet is large, the engine compartment can be opened and closed by performing an operation of swinging only the front bonnet. This facilitates opening and closing the engine compartment. The engine bonnet can be produced by being divided into the front bonnet and the back bonnet. This facilitates production of the engine bonnet.

In one or more embodiments of the present invention,

the front bonnet is supported in a state of being able to swing open and closed, up and down (vertically swingably supported to open and close), by using as a swinging fulcrum a pivot shaft core extending along a vehicle-body lateral width direction at a back end portion of the front bonnet.

According to the present configuration, an operation of raising a front end side of the front bonnet opens the front bonnet, and an operation of lowering the front end side of the front bonnet closes the front bonnet. This facilitates opening and closing the front bonnet.

In one or more embodiments of the present invention,

the front bonnet has a front top plate portion (i.e., a front top plate) and front side plate portions (i.e., front side plates) that extend downward from left and right side portions (i.e., left and right sides) of the front top plate portion, the back bonnet has a back top plate portion (i.e., a back top plate) that covers the back engine compartment portion from above and left and right back side plate portions (i.e., back side plates) that cover the back engine compartment portion from both horizontal sides, provided is a connecting bolt that connects a front portion of the back side plate portion to a support member (i.e., a supporting tool), and the front bonnet is configured to cover the connecting bolt in a closed state with a back portion of the front side plate portion is positioned on a horizontal outer side of the connecting bolt.

According to the present configuration, the front bonnet becomes a cover covering the connecting bolt from the horizontal outer side. As such, a simple cover structure that requires no special cover can prevent, for example, water leakage into the connecting bolt.

In one or more embodiments of the present invention,

the back bonnet has a back top plate portion (i.e., a back top plate) that covers the back engine compartment portion from above and left and right back side plate portions (i.e., back side plates) that cover the back engine compartment portion from both horizontal sides, and the back top plate portion and the left and right back side plate portions are configured as separate bodies.

According to the present configuration, the back bonnet can be produced by being divided into the back top plate portion and the left and right back side plate portions. This facilitates production of the back bonnet.

In one or more embodiments of the present invention,

the second exhaust-gas cleaning device is configured to use a reducing agent to subject the exhaust gas from the engine to the cleaning process (purify the exhaust gas from the engine using the reducing agent), and a reducing-agent tank and a reducing-agent pump, which supplies the reducing agent stored in the reducing-agent tank to the second exhaust-gas cleaning device, are provided on a front side of the engine in the front engine compartment portion.

According to the present configuration, a front-back length of the engine compartment becomes longer due to a space housing the reducing-agent tank and the reducing-agent pump, making an engine bonnet of a longer front-back length necessary. However, the engine bonnet can be produced by being divided into the front bonnet and the back bonnet. This facilitates production of the engine bonnet.

### BRIEF DESCRIPTION OF DRAWINGS

FIG. 1 is a left side view illustrating an entirety of a tractor.

FIG. 2 is a plan view illustrating the entirety of the tractor.

FIG. 3 is a side view illustrating a motor unit.

FIG. 4 is a side view illustrating support structures of a front bonnet and a back bonnet.

FIG. 5 is a front view illustrating the support structure of the back bonnet.

FIG. 6 is a perspective view illustrating the back bonnet, a bonnet support member, and a partition member in an exploded state.

### DETAILED DESCRIPTION OF EMBODIMENTS

Embodiments the present invention are described below based on the drawings.

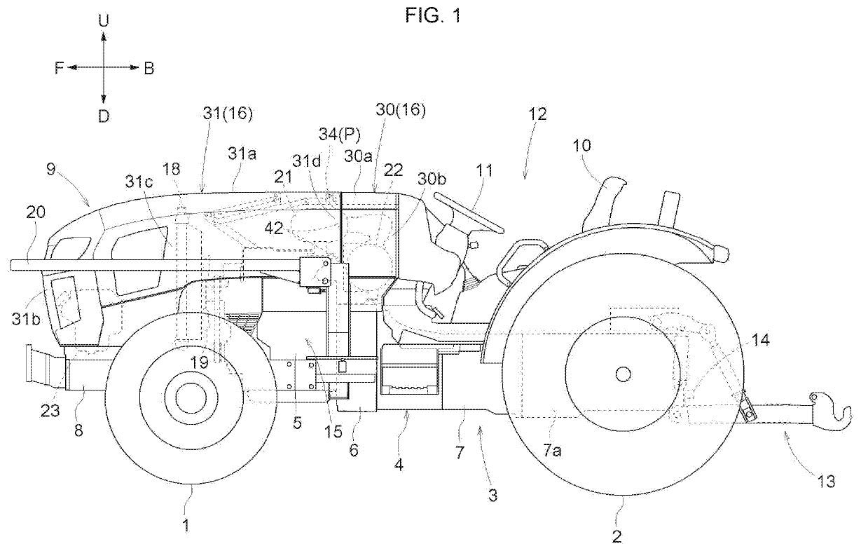

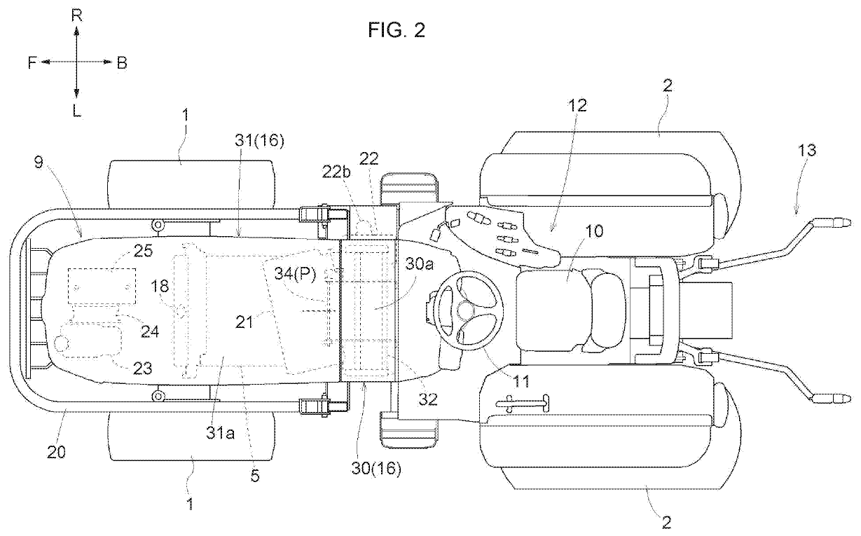

Note that in the following description, in regards to a traveling vehicle body of a tractor, the direction of arrow F illustrated in FIGS. 1 and 2 is defined as “vehicle-body front”, the direction of arrow B is defined as “vehicle-body back”, the direction of arrow U illustrated in FIG. 1 is defined as “vehicle-body up”, the direction of arrow D is defined as “vehicle-body down”, the direction of arrow L illustrated in FIG. 2 is defined as “vehicle-body left”, and the direction of arrow R is defined as “vehicle-body right”.

[Overall Configuration of Tractor]

As illustrated in FIGS. 1 and 2, the tractor is provided with a traveling vehicle body 3 supported by a pair of left and right front wheels 1, which can be steered and driven, and a pair of left and right back wheels 2, which can be driven. A vehicle body frame 4 of the traveling vehicle body 3 is constituted by an engine 5, a flywheel housing 6 connected to a back portion of the engine 5, a clutch housing 7 connected to a back portion of the flywheel housing 6, a transmission case 7a connected to a back portion of the clutch housing 7, and a front frame 8 connected to a lower portion of the engine 5. A motor unit 9 provided with the engine 5 is formed in a front portion of the traveling vehicle body 3. A driver's seat 10 and a driving unit 12, which is provided with a steering wheel 11 whereby a steering operation of the front wheels 1 is performed, are formed in a back portion of the traveling vehicle body 3. A linking mechanism 13, which connects a work apparatus such as a rotary tilling apparatus (not illustrated) in a manner enabling a raising and lowering operation of the work apparatus, and a power takeoff shaft 14, which takes power from the engine 5 and outputs this to the connected work apparatus, are provided in a back portion of the transmission case 7a. 20 illustrated in FIGS. 1 and 2 is a ROPS frame. The ROPS frame 20 is configured to be able to change attitudes between a storage attitude, which is a collapsed state of surrounding the motor unit 9, and a usage attitude, which is a raised state.

[Configuration of Motor Unit]

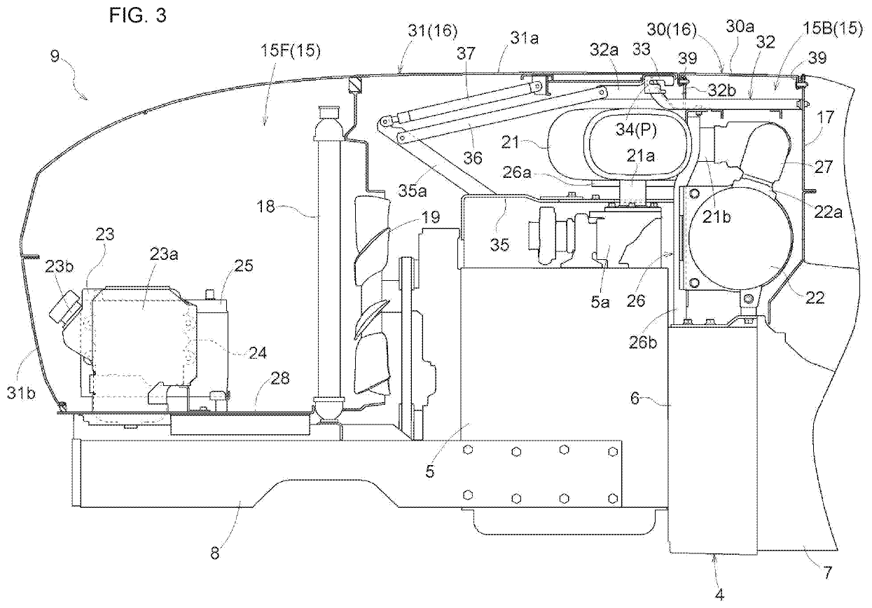

As illustrated in FIGS. 1 and 3, the motor unit 9 is provided with an engine compartment 15. The engine compartment 15 is formed by an engine bonnet 16, which covers the engine compartment 15 from above, the front, and both horizontal sides; a partition member 17 that forms a partition between the engine compartment 15 and the driving unit 12; and the like.

As illustrated in FIGS. 1, 2 and 3, the engine 5, a radiator 18 that cools the engine 5, a first exhaust-gas cleaning device (DPF) 21 and second exhaust-gas cleaning device (SCR) 22 that perform cleaning processes of exhaust gas exhausted by the engine 5, a reducing-agent tank 23, a reducing-agent pump 24, and a battery 25 are provided in the engine compartment 15.

[Configuration of Radiator]

As illustrated in FIGS. 1, 2, and 3, the radiator 18 is provided in front of the engine 5. A blowing action of a rotary fan 19 positioned between the radiator 18 and the engine 5 introduces cooling air from outside the engine compartment 15 to inside the engine compartment and supplies the cooling air to the radiator 18. The cooling air is supplied to the radiator 18 in a state of the cooling air passing through the radiator 18 from front to back. In the radiator 18, engine cooling water is cooled by heat exchange between the supplied cooling air and the engine cooling water. The engine 5 is cooled by the cooled engine cooling water being supplied to the engine 5.

[Configurations of First Exhaust-Gas Cleaning Device and Second Exhaust-Gas Cleaning Device]

The engine 5 is a diesel engine. As illustrated in FIGS. 2 and 3, the first exhaust-gas cleaning device 21 is provided above the engine 5 in a state wherein a long side of the first exhaust-gas cleaning device is substantially parallel to a vehicle-body lateral width direction (or a vehicle-body horizontal direction). A support member (i.e., the supporting tool) 26 is erected on the flywheel housing 6. A lower portion of the first exhaust-gas cleaning device 21 is supported by a support arm 26a provided to the support member 26. The first exhaust-gas cleaning device 21 is supported by the flywheel housing 6 of the vehicle body frame 4 via the support member 26. An exhaust-gas suctioning portion 21a, which is provided to a part on one end side, in the vehicle-body lateral width direction, of the first exhaust-gas cleaning device 21, and an exhaust-gas exhausting portion 5a, which is provided to the engine 5, are connected. An exhaust-gas discharging portion 21b is provided to a part on another end side, in the vehicle-body lateral width direction, of the first exhaust-gas cleaning device 21.

In the first exhaust-gas cleaning device 21, the exhaust gas exhausted by the engine 5 from the exhaust-gas exhausting portion 5a is suctioned by the exhaust-gas suctioning portion 21a into the apparatus, and diesel microparticles included in the suctioned exhaust gas are collected by a collection filter (not illustrated). This performs an exhaust-gas cleaning process of decreasing the diesel microparticles. The exhaust gas subjected to the cleaning process is discharged from the exhaust-gas discharging portion 21b.

As illustrated in FIGS. 2 and 3, the second exhaust-gas cleaning device 22 is provided behind the engine 5 in a state wherein a long side of the second exhaust-gas cleaning device is substantially parallel to the vehicle-body lateral width direction. A front portion of the second exhaust-gas cleaning device 22 is supported by a strut portion 26b provided to the support member 26. The second exhaust-gas cleaning device 22 is supported by the flywheel housing 6 of the vehicle body frame 4 via the support member 26. An exhaust-gas introduction portion 22a, which is provided to a part on one end side, in the vehicle-body lateral width direction, of the second exhaust-gas cleaning device 22, and the exhaust-gas discharging portion 21b of the first exhaust-gas cleaning device 21 are connected by a connecting pipe 27. An exhaust-gas discharging portion 22b is provided to a part on another end side, in the vehicle-body lateral width direction, of the second exhaust-gas cleaning device 22.

In the second exhaust-gas cleaning device 22, the exhaust gas discharged by the first exhaust-gas cleaning device 21 from the exhaust-gas discharging portion 21b is supplied by the connecting pipe 27 to the exhaust-gas introduction portion 22a and introduced by the exhaust-gas introduction portion 22a into the apparatus, and the introduced exhaust gas is subjected to the cleaning process by a reducing agent. Specifically, aqueous urea as the reducing agent is injected into the introduced exhaust gas, hydrolyzing the exhaust gas. This performs an exhaust-gas cleaning process of decreasing nitrogen oxides included in the exhaust gas. The exhaust gas subjected to the cleaning process is exhausted from the exhaust-gas discharging portion 22b to a vehicle-body horizontal outer side.

As illustrated in FIGS. 2 and 3, the reducing-agent tank 23, the reducing-agent pump 24, and the battery 25 are provided on a front side of the engine 5. In one or more embodiments, the reducing-agent tank 23, the reducing-agent pump 24, and the battery 25 are lined up in the vehicle-body lateral width direction. A support plate 28 is provided on an upper side of the front frame 8. The reducing-agent tank 23 is supported by the support plate 28 via a tank case 23a. The reducing-agent tank 23 has a pour tube 23b that extends forward and upward from an upper portion of the reducing-agent tank 23 and stores the aqueous urea as the reducing agent by the aqueous urea being poured in from the pour tube 23b. The reducing-agent pump 24 extracts the aqueous urea stored in the reducing-agent tank 23 from the reducing-agent tank 23 and supplies the extracted aqueous urea to the second exhaust-gas cleaning device 22 via a hose (not illustrated) extending from the reducing-agent pump 24 to the second exhaust-gas cleaning device 22.

[Configuration of Engine Bonnet]

As illustrated in FIGS. 1, 2, and 3, the engine bonnet 16 has a back bonnet 30, which covers a back engine compartment portion 15B—wherein the second exhaust-gas cleaning device 22 is positioned—of the engine compartment 15, and a front bonnet 31, which covers a front engine compartment portion 15F—disposed further toward a vehicle-body front side than the back engine compartment portion 15B—of the engine compartment 15. The front engine compartment portion 15F houses the first exhaust-gas cleaning device 21, the engine 5, the radiator 18, the reducing-agent tank 23, the reducing-agent pump 24, and the battery 25. The front bonnet 31 and the back bonnet 30 are configured as separate bodies.

[Configuration of Front Bonnet]

As illustrated in FIGS. 1, 2, and 3, the front bonnet 31 has a front top plate portion 31a that covers the front engine compartment portion 15F from above, a front grille portion 31b that extends downward from a front portion of the front top plate portion 31a and covers the front engine compartment portion 15F from the front, and left and right front side plate portions 31c that extend downward from both horizontal side portions of the front top plate portion 31a and cover the front engine compartment portion 15F from both horizontal sides.

The front bonnet 31 is supported in a state wherein it can be opened and closed.

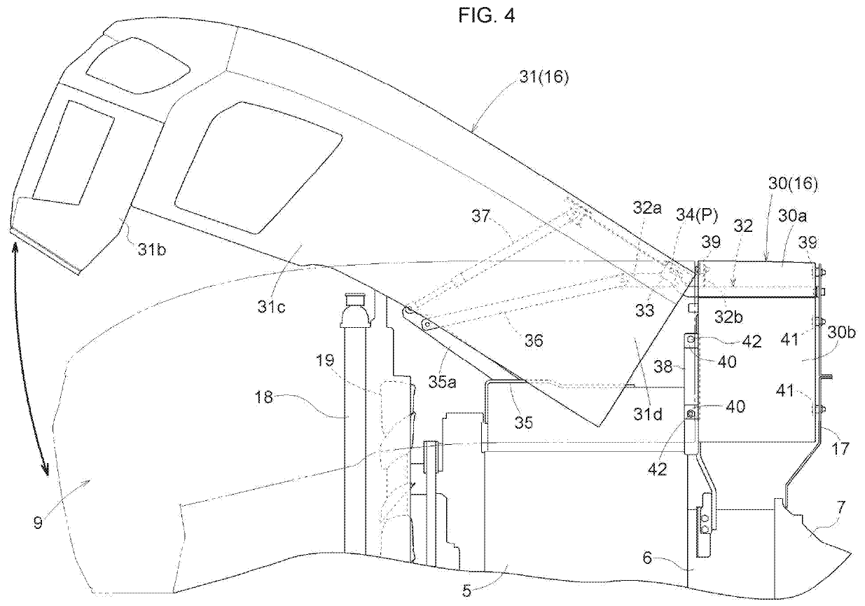

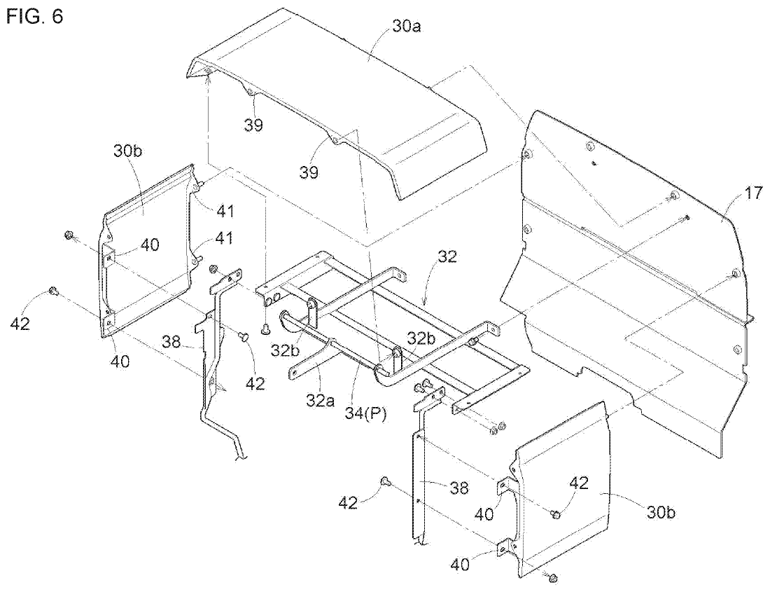

Specifically, as illustrated in FIGS. 2, 3, and 4, a bonnet support member 32 extending forward from an upper portion of the partition member 17 is provided in a back portion of the engine compartment 15. As illustrated in FIG. 6, the bonnet support member 32 is configured by combining a plurality of steel members extending in a vehicle-body longitudinal (front-back) direction and a plurality of steel members extending in the vehicle-body lateral width direction. As illustrated in FIGS. 3 and 6, a pivot shaft 34 extending in the vehicle-body lateral width direction is provided across a connecting portion 33, provided to a back end portion of the front bonnet 31, and a front portion of the bonnet support member 32. The front bonnet 31 is supported by the bonnet support member 32 in a state of being able to swing between a raised, open state—wherein, as illustrated by the solid lines in FIG. 4, the engine compartment 15 is opened by using, as a swinging fulcrum, a pivot shaft core P extending in the vehicle-body lateral width direction of the pivot shaft 34—and a lowered, closed state—wherein, as illustrated by the dot-dot-dash lines in FIG. 4, the engine compartment 15 is closed.

As illustrated in FIG. 3, a support member 35 extends forward, passing above the engine 5, from the support member 26 of the first exhaust-gas cleaning device 21 and the second exhaust-gas cleaning device 22. A support rod 36 that causes the support member 35 to support the bonnet support member 32 is connected across an arm portion 35a provided to a front portion of the support member 35 and an arm portion 32a provided to the front portion of the bonnet support member 32. A damper 37 that biases the front bonnet 31 to the open state is connected across the arm portion 35a and an inner portion of the front bonnet 31.

[Configuration of Back Bonnet]

As illustrated in FIGS. 1, 2, and 3, the back bonnet 30 has a back top plate portion 30a, which covers the back engine compartment portion 15B from above, and left and right back side plate portions 30b, which cover the back engine compartment portion 15B from both horizontal sides. As illustrated in FIG. 6, the back top plate portion 30a and the left and right back side plate portions 30b are configured as separate bodies. The back top plate portion 30a and the left and right back side plate portions 30b are constituted by sheet-metal members.

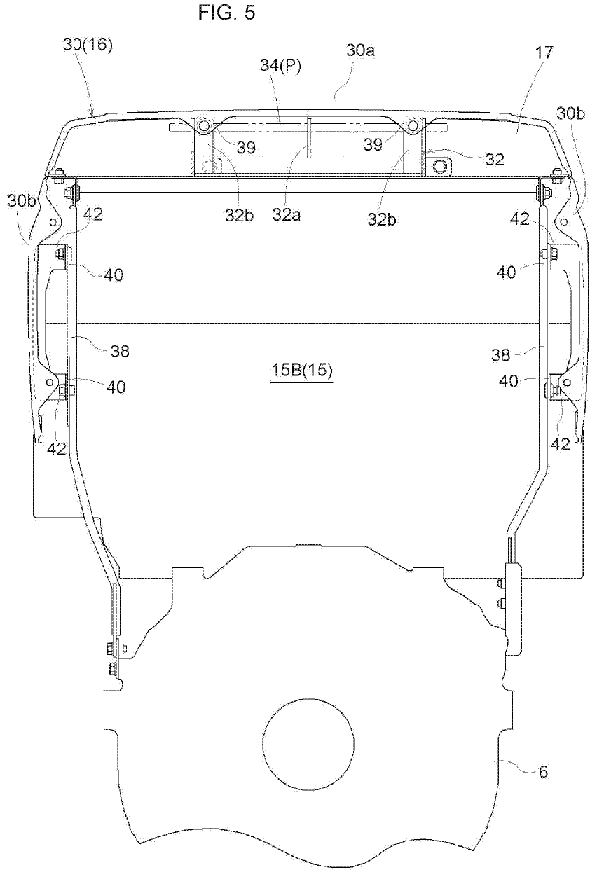

As illustrated in FIGS. 4 and 5, the back bonnet 30 is configured to be supported by the partition member 17, the bonnet support member 32, and side-plate support members 38.

Specifically, as illustrated in FIGS. 4 and 5, the side-plate support members 38 extend upward from both horizontal side portions of the flywheel housing 6. Upper end portions of the side-plate support members 38 are connected to a front side portion of the bonnet support member 32, and the side-plate support members 38 are configured to serve as support members of the bonnet support member 32.

As illustrated in FIG. 6, connecting portions 39 are respectively provided to a front portion and a back portion of the back top plate portion 30a. In one or more embodiments, the front portion and the back portion of the back top plate portion 30a are each provided with two connecting portions 39. As illustrated in FIGS. 3, 4, and 5, the back top plate portion 30a is supported by the partition member 17 and the bonnet support member 32 by the connecting portions 39 of the back portion being pin-connected to the partition member 17 and the connecting portions 39 of the front portion being pin-connected to a support portion 32b provided to the front portion of the bonnet support member 32.

As illustrated in FIG. 6, at each of the left and right back side plate portions 30b, a front connecting portion 40 is provided to a front portion of the back side plate portion 30b and a back connecting portion 41 is provided to a back portion of the back side plate portion 30b. In one or more embodiments, two front connecting portions 40 and two back connecting portions 41 are provided. As illustrated in FIGS. 4 and 5, the left and right back side plate portions 30b are each supported by the side-plate support member 38 and the partition member 17 by the front connecting portion 40 being connected to the side-plate support member 38 by a connecting bolt 42 and the back connecting portion 41 being pin-connected to the partition member 17.

As illustrated by the solid lines in FIG. 1 and the dot-dot-dash lines in FIG. 4, the front bonnet 31 is configured so in the closed state, a back portion 31d of the front side plate portion 31c of the front bonnet 31 is positioned on a horizontal outer side of the connecting bolt 42 so as to cover the connecting bolt 42. The front side plate portion 31c of the front bonnet 31 prevents exposure of and water leakage into the connecting bolt 42.

The engine bonnet 16 has the back bonnet 30, which covers the back engine compartment portion 15B—wherein the flywheel housing 6 is positioned—of the engine compartment 15, and the front bonnet 31, which covers the front engine compartment portion 15F—disposed further toward the vehicle-body front side than the back engine compartment portion 15B—of the engine compartment 15. The front bonnet 31 and the back bonnet 30 are configured as separate bodies. The front bonnet 31 is supported in a state wherein it can swing open and closed.

### Other Embodiments

(1) The above embodiments illustrate an example wherein the front bonnet 31 is supported so as to be able to swing open and closed, up and down, by using as a swinging fulcrum the pivot shaft core P in the vehicle-body lateral width direction provided to the back end portion of the front bonnet 31. However, the present invention is not limited thereto. For example, the front bonnet may be supported so as to be able to swing open and closed, up and down, by using as a swinging fulcrum a pivot shaft core in the vehicle-body lateral width direction positioned in a front end portion of the front bonnet 31. Alternatively, the front bonnet may be supported so as to be able to swing open and closed by using as a swinging fulcrum a pivot shaft core positioned in a state of extending in the vehicle-body longitudinal direction to a horizontal side portion of the front bonnet 31.

(2) The above embodiments illustrate an example wherein the back top plate portion 30a and the left and right back side plate portions 30b are configured as separate bodies. However, these may be integrally configured.

(3) The above embodiments illustrate an example of adopting a configuration wherein the connecting bolt 42 is covered from the horizontal side by the back portion 31d of the front bonnet 31 in the closed state. However, this configuration does not need to be adopted.

(4) The above embodiments illustrate an example wherein the reducing-agent tank 23 and the reducing-agent pump 24 are provided on the front side of the engine 5 in the front engine compartment portion 15F, but the present invention is not limited thereto.

For example, the reducing-agent tank 23 and the reducing-agent pump 24 may be provided in any location, such as outside the engine compartment 15.

### INDUSTRIAL APPLICABILITY

The one or more embodiments of present invention can be applied in tractors provided with an engine bonnet forming an engine compartment, a first exhaust-gas cleaning device provided above an engine in the engine compartment, and a second exhaust-gas cleaning device provided behind the engine.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. A tractor comprising:
a vehicle body;
an engine bonnet that forms an engine compartment;
an engine disposed in the engine compartment;
a first exhaust-gas cleaning device disposed above the engine in the engine compartment and purifies exhaust gas from the engine; and
a second exhaust-gas cleaning device disposed behind the engine and purifies the exhaust gas from the engine, wherein
the engine compartment includes:
a back engine compartment portion in which the second exhaust-gas cleaning device is disposed, and
a front engine compartment portion disposed further toward a vehicle-body front side than the back engine compartment portion,
the engine bonnet includes:
a back bonnet that covers the back engine compartment portion,
a front bonnet, that is configured as a separate body from the back bonnet and covers the front engine compartment portion, and
the front bonnet is swingably supported to open and close.

2. The tractor of claim 1, wherein
the front bonnet is vertically swingably supported to open and close using as a fulcrum a pivot shaft core extending along a vehicle-body lateral width direction at a back end portion of the front bonnet.

3. The tractor of claim 2, wherein
the front bonnet comprises:
a front top plate, and
front side plates that extend downward from left and right sides of the front top plate,
the back bonnet comprises:
a back top plate that covers the back engine compartment portion from above, and
back side plates that cover the back engine compartment portion from both horizontal sides,
the tractor further comprises:
a supporting tool, and
a connecting bolt that connects a front portion of each of the back side plates to the supporting tool, and
the front bonnet is configured to cover the connecting bolt in a closed state with a back portion of each of the front side plates positioned on a horizontal outer side of the connecting bolt.

4. The tractor of claim 1, wherein
the back bonnet comprises:
a back top plate that covers the back engine compartment portion from above, and
back side plates that cover the back engine compartment portion from both horizontal sides, and
the back top plate and the back side plates are configured as separate bodies.

5. The tractor of claim 1, wherein
the second exhaust-gas cleaning device is configured to purify the exhaust gas from the engine using a reducing agent, and
the tractor further comprises:
a reducing-agent tank that stores the reducing agent, and
a reducing-agent pump that supplies the reducing agent from the reducing-agent tank to the second exhaust-gas cleaning device, and
the reducing-agent tank and the reducing-agent pump are disposed on a front side of the engine in the front engine compartment portion.
